(19) United States
(12) Patent Application Publication
(10) Pub. No.: US 2017/0178612 A1
(43) Pub. Date: Jun. 22, 2017

(54) MECHANIZED SPRING DRUM

(71) Applicant: Pragmatic Designs Inc., Sandy Hook, CT (US)

(72) Inventor: Julia D. Truchsess, Sandy Hook, CT (US)

(73) Assignee: Pragmatic Designs Inc., Sandy Hook, CT (US)

(21) Appl. No.: 15/385,196

(22) Filed: Dec. 20, 2016

Related U.S. Application Data
(60) Provisional application No. 62/270,228, filed on Dec. 21, 2015.

(51) Int. Cl. G10K 9/12; A63H 33/00; A63H 33/26

(52) U.S. Cl. CPC G10K 9/12; A63H 33/26; A63H 33/00

(57) ABSTRACT

Embodiments of the present disclosure are directed to an apparatus for generating a sound effect. The apparatus may include a hollow body, which may define at least partially a cavity. The body is open at a first end and closed by a membrane at the second end. The apparatus may further include a spring attached to the membrane on the second end of the body, a motor removably or fixedly mounted on the body, and an eccentric weight removably or fixedly attached to the motor and configured to rotate with the motor when the motor is activated.

### CROSS-REFERENCE TO RELATED APPLICATION

This application is based upon and claims the benefit of priority of U.S. Provisional Application No. 62/270,228, filed on Dec. 21, 2015, the entirety of which is incorporated herein by reference.

### TECHNICAL FIELD

The present disclosure relates to the fields of sound generating novelties and musical instruments.

### BACKGROUND OF THE DISCLOSURE

The “spring drum,” also known as “thunder tube,” was invented by percussionist Trilok Gurtu, and has been commercialized by Remo Inc. and others as both a musical instrument and a novelty “noisemaker” device. The spring drum consists of a resonant tube, open at one end and closed by a membrane at the other, with a spring attached to the membrane near its center. When the instrument is moved in a certain way and at a certain speed, the vibrations of the spring and membrane combine with each other and the tube's resonance to create a crescendo of sound reminiscent of thunder.

A limitation of existing spring drums is that they must be manually operated by moving or shaking the instrument with one's hand. This manual operation may not be suitable for applications that can benefit from autonomous, remote, or other form of indirect or machine-controlled operation, such as windchimes, doorbells, annunciators, and the like.

### SUMMARY OF THE DISCLOSURE

Embodiments of the present disclosure are directed to a spring drum which is operated by electromechanical means.

In one embodiment of the present disclosure, an apparatus for generating a sound is provided. The apparatus may include a hollow body. The body may at least partially define a cavity. The body may be open at a first end and closed by a membrane at a second end. The apparatus may further include a spring attached to the membrane on the second end of the body, a motor removably or fixedly mounted on the body, and an eccentric weight removably or fixedly attached to the motor and configured to rotate with the motor when the motor is activated.

In one embodiment of the present disclosure, an electromechanical spring drum is provided. The electromechanical spring drum includes a mechanism that contributes a minimum of extraneous sound or noise in addition to that normally produced by a spring drum.

In one embodiment of the present disclosure, an electromechanical spring drum is provided. The electromechanical spring drum is responsive to rapid changes in its control signal(s).

In one embodiment of the present disclosure, an electromechanical spring drum is provided. The electromechanical spring drum includes a mechanism that is compact.

In one embodiment of the present disclosure, an electromechanical spring drum is provided. The electromechanical spring drum is low in cost and easy to manufacture.

In one embodiment of the present disclosure, a novel and entertaining electrically-controlled sound generating device is provided. The device is applicable to many uses.

### BRIEF DESCRIPTION OF THE DRAWINGS

FIG. 1 is a cross-section view of an example of a spring drum.

FIG. 2 is a cross-section view of an exemplary spring drum, according to embodiments of the present disclosure.

### DETAILED DESCRIPTION OF THE DISCLOSURE

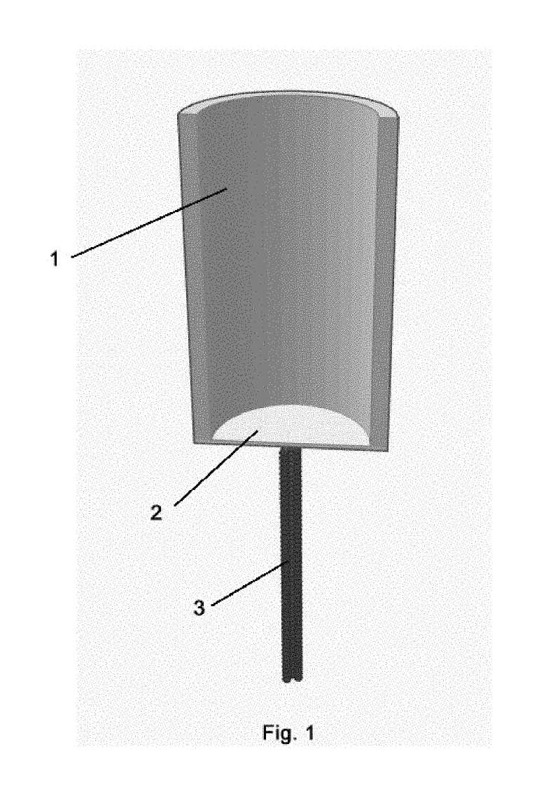

FIG. 1 shows an exemplary spring drum. The spring drum may include a body 1, which at least partially defines a resonant cavity, a membrane 2, and a spring 3. Body 1 is open at one end and closed at the opposite end by membrane 2. Spring 3 is attached to membrane 2 by some kind of mechanical fastening. When body 1 is held in the operator's hand and rocked back and forth around an axis perpendicular to its long axis near its center at the right speed, standing wave vibrations will build in spring 3 and be conducted to membrane 2, causing sound waves to build at or near the resonant frequency of the cavity inside body 1, resulting in a “thunder” sound effect. Body 1 may have any shape suitable to have a resonant frequency, such as a cylinder, a polygon, a truncated cone, a funnel, or may be designed to have a customized shape.

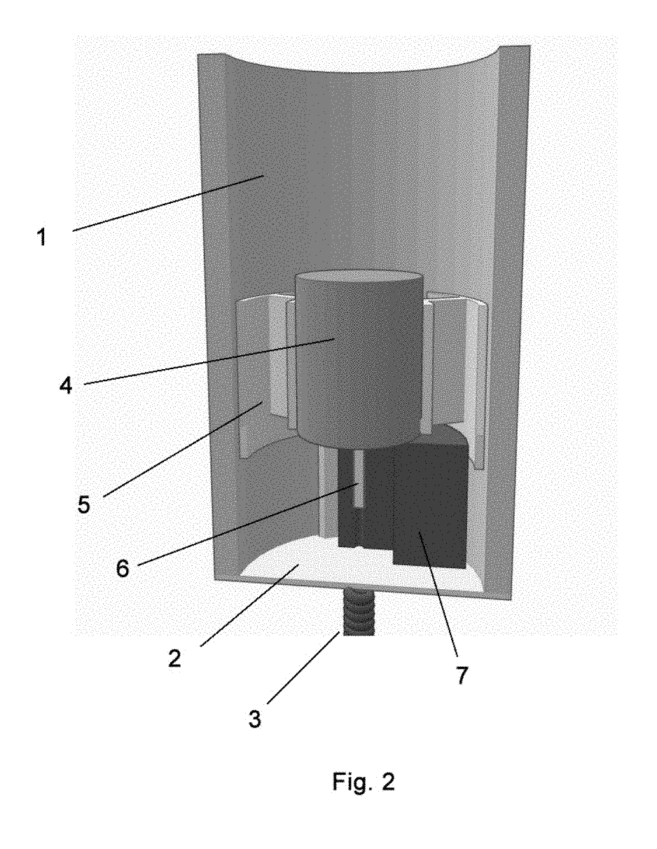

FIG. 2 illustrates an exemplary spring drum, according to embodiments of the present disclosure. As shown in FIG. 2, the spring drum may further include an motor 4, a supporting frame 5, and/or an eccentric weight 7. In this example, motor 4 is mounted in supporting frame 5 within body 1. Eccentric weight 7 is removably or fixedly attached to a shaft 6 of motor 4. When electric power is applied to motor 4 via conducting wires (not shown), shaft 6 and eccentric weight 7 attached to shaft 6 may rotate. The eccentricity of the rotating eccentric weight 7 causes the entire assembly, i.e., the spring drum, to wobble. If body 1 is suspended or held at a point along its length allowing the end near spring 3 to wobble, vibrations will build in spring 3 and sound waves in the cavity of body 1 will cause sound to be emitted.

In some embodiments, motor 4 and supporting frame 5 may be mounted in various places inside body 1, for example, distributed along the longitudinal axis of body 1. In some embodiments, motor 4 and supporting frame 5 may be mounted outside body 1. In such situations, shaft 6 may be designed to translate the rotation of motor 4 to eccentric weight 7 when motor 4 rotates and thus may cause the spring drum assembly to wobble. The locations for a sensor could be devised to sense gusts of wind, and by electrical, electromechanical, electronic means, or a combination thereof, may deliver a measured burst of power to motor.

In some embodiments, the spring drum device according to the present disclosure may include more than one motor 4, supporting frame 5, and/or eccentric weight 7. The number of each of these components may depend on the sound effect desirable for a particular application of the spring drum device.

Electric power can be applied to motor 4 at any time and for any duration, depending on the application and desired sound effect, and may be controlled by any suitable means. In a doorbell application, for instance, the motor power could be controlled by a doorbell button. In a wind chime application, a sensor could be devised to sense gusts of wind, and by electrical, electromechanical, electronic means, or a combination thereof, may deliver a measured burst of power to motor 4 at each gust. When the spring drum is used as an electronic musical instrument, trigger pulses or MIDI code could be used to control and/or apply electrical power to motor 4.

Electrical power for the device, i.e., the spring drum, can be derived from any source suitable to provide sufficient current to rotate motor 4 and weight 7. These sources include but are not limited to mains power, storage batteries, photovoltaic solar panels, capacitors, wind turbines, and combinations thereof.

In some embodiments, motor 4 may be activated by any suitable electronic and/or mechanical mechanism. For example, motor 4 may include a switch, a sensor, and/or electronic circuits for activation. In some embodiments, motor 4 may be activated when the switch is manually turned on. In some embodiments, motor 4 may be activated when the sensor receives a control signal from a remote control device on via a wireless communication method. In some embodiments, motor 4 may be activated when the sensor detects a change in the environment, such as temperature, heat, voice, sound level, wind, light, or combination thereof.

While the exemplary embodiments described herein use an electric motor and a rotating eccentric weight to cause a rocking motion, other configurations for translating energy to the rocking motion to create the desired vibrations in the spring and membrane are possible, including motor-driven linkages, gear trains, solenoids, electromagnets, compressed air, wind turbines, water wheels, etc.

Thus, one of skill in the art will see that embodiments of the present disclosure provide novel devices and methods for generating the “thunder tube” sound effect electronically and/or mechanically.

What is claimed is:

1. An apparatus for generating a sound, the apparatus comprising:
a hollow body, open at a first end and closed by a membrane at a second end;
a spring attached to the membrane on the second end of the body;
a motor removably or fixedly mounted on the body; and
an eccentric weight removably or fixedly attached to the motor and configured to rotate with the motor when the motor is activated.

2. The apparatus of claim 1, wherein the spring is attached to the membrane on the second end of the body near the center of the membrane.

3. The apparatus of claim 1, wherein the motor may be electric or mechanical.

4. The apparatus of claim 1, further comprising a sensor, operatively connected to the motor, which causes the motor to operate when a sensed condition occurs.

5. The apparatus of claim 1, wherein the motor is removably or fixedly mounted within the body.

6. The apparatus of claim 1 or 5, wherein the location of the motor within the body may be adjusted to create different sound effects.
